(19) United States
(12) Patent Application Publication
(10) Pub. No.: US 2010/0164456 A1
(43) Pub. Date: Jul. 1, 2010

(54) CONTROL CIRCUIT AND CONTROL METHOD FOR SWITCHING REGULATOR

(75) Inventor: Manabu OYAMA, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/648,212

(22) Filed: Dec. 28, 2009

(30) Foreign Application Priority Data
Dec. 26, 2008 (JP) 2008-332181

(51) Int. Cl. G05F 1/10

(52) U.S. Cl. 323/283

(57) ABSTRACT

A first comparator compares a feedback voltage that corresponds to the output voltage of a switching regulator with a threshold voltage having hysteresis. The first comparator outputs a voltage comparison signal which is asserted when the feedback voltage is smaller than the threshold voltage. A second comparator generates a current comparison signal which is asserted when an electric current that flows through a switching transistor reaches a reference current. During a period in which the voltage comparison signal is asserted, a logic unit performs an operation in which, when the current comparison signal is asserted, a control signal is set to a second level at which the switching transistor is turned off, following which, after the passage of a predetermined OFF time, the control signal is set to a first level at which the switching transistor is turned on.

### BACKGROUND OF THE INVENTION

1. Field of the Invention

The present invention relates to a switching regulator, and particularly to a technique for reducing power consumption thereof.

2. Description of the Related Art

In recent years, electronic apparatuses such as cellular phones, PDAs (Personal Digital Assistants), digital still cameras, etc., mount an IC or an electronic component which requires higher or lower voltage than the output voltage of a battery. In order to generate such a voltage that is higher or lower than the battery voltage, a switching regulator is employed so as to boost or step down the battery voltage.

As a method whereby a control circuit that controls the ON/OFF operation of a switching element of a switching regulator controls the switching element, a pulse width modulation method is widely used in which the output voltage of the switching regulator is compared with a reference voltage which is a target value, and the pulse width of a driving signal is adjusted so as to obtain the smallest difference in voltage therebetween. With the pulse width modulation method, the step-up ratio is adjusted according to the battery voltage by adjusting the time ratio of the ON time during which the switching element is turned on, i.e., the duty ratio, thereby allowing a constant output voltage to be maintained.

There is a significant problem with such a switching regulator in that the conversion efficiency thereof must be improved in a light-load state when the load current is small. The Patent Documents listed below disclose a method in which the switching operation of the switching transistor is stopped for a predetermined period in a light-load state, thereby reducing power consumption (current consumption). With such a method, the frequency with which the switching element is turned on changes according to the load state. Accordingly, such a method is also referred to as a “pulse frequency modulation (PFM) method”.

### [Patent Document 1]

Japanese Patent Application Laid Open No. 2003-309966

[Patent Document 2]

### Japanese Patent Application Laid Open No. 2006-295802

### [Patent Document 3]

Japanese Patent Application Laid Open No. 2008-67505

### [Patent Document 4]

Japanese Patent Application Laid Open No. 2008-148502

The PFM switching regulators described in Patent Documents 1 through 3 include an oscillator, and are configured to control the timing of the ON/OFF operation of a switching element using a clock pulse output from the oscillator as a reference signal. As an original method, the PFM method is a technique for reducing power consumption of a switching regulator when the load is light, thereby improving the efficiency thereof. However, the switching regulator which operates at an increased frequency leads to increased current consumption of such an oscillator. Accordingly, power consumption of the switching regulator in the PFM mode depends on the power consumption of the oscillator.

### SUMMARY OF THE INVENTION

The present invention has been made in order to solve such a problem. Accordingly, it is a general purpose of the present invention to provide a switching regulator having further improved efficiency in a light-load state.

An embodiment of the present invention provides a control circuit for a switching regulator having a switching transistor. The control circuit comprises: a first comparator configured to compare a feedback voltage that corresponds to the output voltage of the switching regulator with a predetermined lower threshold voltage, and to output a voltage comparison signal which is asserted when the feedback voltage drops to the lower threshold voltage; a second comparator configured to compare an electric current that flows through the switching transistor with a predetermined reference current, and to generate a current comparison signal which is asserted when the current reaches the reference current; a logic unit configured to receive the voltage comparison signal and the current comparison signal, and to generate a control signal which is set to a first-level state during a period in which the switching transistor is to be turned on, and which is set to a second-level state during a period in which the switching transistor is to be turned off; and a driver configured to drive the switching transistor according to the control signal. During a period in which the voltage comparison signal is asserted, the logic unit repeatedly performs an operation in which, when the current comparison signal is asserted, the control signal is set to the second level, following which, after the passage of a predetermined period of OFF time, the control signal is set to the first level.

Such an embodiment does not require an oscillator, thereby providing reduced power consumption when the load is light.

Also, the first comparator may be a hysteresis comparator configured to use, as threshold voltages thereof, the lower threshold voltage and an upper threshold voltage which is higher than the lower threshold voltage. When the feedback voltage is smaller than the threshold voltage, the first comparator may assert the voltage comparison signal.

By employing such a hysteresis comparator, such an arrangement is capable of setting a voltage range within which the output voltage changes.

With such an embodiment, the logic unit may comprise: a gate signal generating unit configured to receive a pulse signal having a logic level that corresponds to the control signal, and to generate a gate signal which is asserted after the passage of the OFF time when the pulse signal is switched to the first level; an AND gate configured to generate the logical sum (AND) of the gate signal and the voltage comparison signal; and a flip-flop configured to generate the control signal which is set to the first level when the output signal of the AND gate is asserted, and which is set to the second level when the current comparison signal is asserted.

Also, the circuit components may be monolithically integrated on a single semiconductor substrate. Examples of “arrangements monolithically integrated” include: an arrangement in which all the elements of a circuit are formed on a single semiconductor substrate; and an arrangement in which principal elements of a circuit are monolithically integrated. Also, a part of the resistors, capacitors, and so forth, for adjusting circuit constants, may be provided to the semiconductor substrate in the form of external elements. By monolithically integrating the control circuit, such an arrangement provides a reduced circuit area.

Another embodiment of the present invention relates to a switching regulator. The switching regulator comprises: a switching transistor; an inductor arranged such that a switching voltage generated by turning on and off the switching transistor is applied to one terminal of the inductor; a rectifier element configured to rectify a current that flows through the inductor; an output capacitor charged by the current that flows through the inductor; and a control circuit according to any one of the above-descried embodiments, configured to control the ON/OFF operation of the switching transistor.

Yet another embodiment of the present invention relates to a method for controlling the ON/OFF state of a switching transistor included in a switching regulator. This method comprises the following Steps 1 through 3.

1. Comparing a feedback voltage that corresponds to the output voltage of the switching regulator with a predetermined lower threshold voltage, and generating a voltage comparison signal which is asserted when the feedback voltage drops to the lower threshold voltage.
2. Comparing an electric current that flows through the switching transistor with a predetermined reference current, and generating a current comparison signal which is asserted when the current reaches the reference current.
3. Generating, based upon the voltage comparison signal and the current comparison signal, a control signal which is set to a first-level state during a period in which the switching transistor is to be turned on, and which is set to a second-level state during a period in which the switching transistor is to be turned off.

In Step 3, during a period in which the voltage comparison signal is asserted, an operation is repeatedly performed in which, when the current comparison signal is asserted, the control signal is set to the second level at which the switching transistor is turned off, following which, after the passage of a predetermined OFF time, the control signal is set to the first level at which the switching transistor is turned on.

With such an embodiment, the control signal is generated in a self-exciting manner. Thus, such an embodiment does not require a circuit such as an oscillator for generating a cyclic signal, thereby reducing power consumption.

In Step 1, the comparison between the feedback voltage and the lower threshold voltage is made by a hysteresis comparator which uses, as threshold voltages, the lower threshold voltage and an upper threshold voltage which is higher than the lower threshold voltage.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows the configuration of a switching regulator according to an embodiment of the present invention; and

FIG. 2 is a time chart which shows the operation of a control circuit shown in FIG. 1 in a light-load state.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

In the same way, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

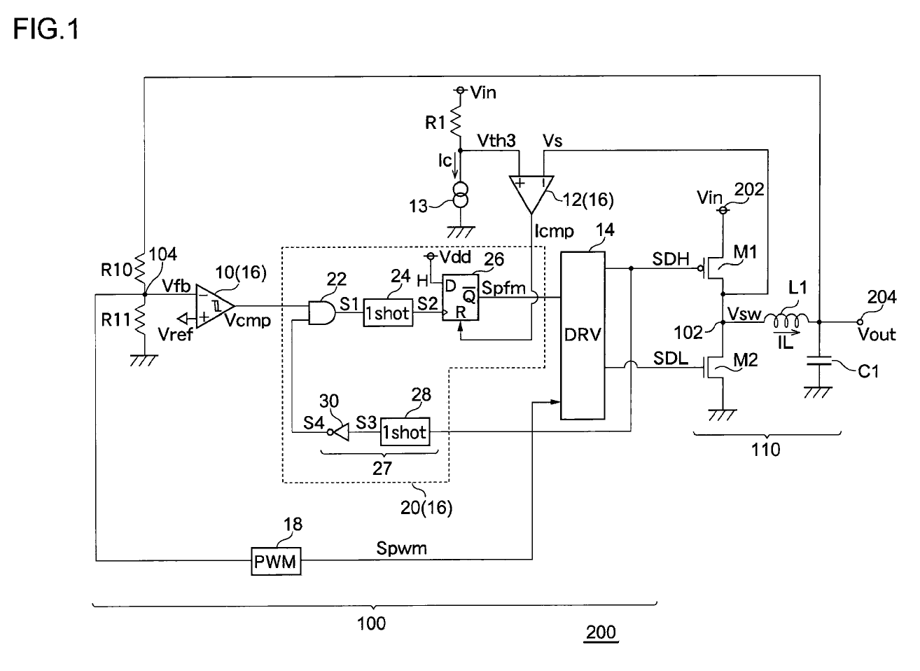

FIG. 1 shows a configuration of a switching regulator 200 according to an embodiment of the present invention. The switching regulator 200 according to the present embodiment is a step-down synchronous rectification switching regulator, and has a configuration including two blocks, i.e., a control circuit 100 thereof and a switching regulator output circuit (which will simply be referred to as an “output circuit” hereafter) 110. The switching regulator 200 steps down an input voltage Vin input via an input terminal 202, stabilizes the voltage thus stepped down, and outputs the output voltage Vout thus stabilized via an output terminal 204.

The output circuit 110 includes a switching transistor M1, a synchronous rectification transistor M2, an output inductor L1, and an output capacitor C1.

The switching transistor M1 is a P-channel MOSFET (Metal Oxide Semiconductor Field Effect Transistor) with one terminal (source terminal) thereof connected to the input terminal 202, and with the other terminal (drain terminal) thereof connected to a switching terminal 102. A driving signal SDH is applied to the gate of the switching transistor M1. When the driving signal SDH is in the low-level (first level) state, the switching transistor M1 is turned on. When the driving signal SDH is in the high-level (second level) state, the switching transistor M1 is turned off.

The synchronous rectification transistor M2 is an N-channel MOSFET, and is provided between the switching terminal 102 and the ground terminal. A driving signal SDL is applied to the gate of the synchronous rectification transistor M2 so as to turn ON and turn OFF the synchronous rectification transistor M2, complementarily to the switching transistor M1. The synchronous rectification transistor M2 functions as a rectifier element which rectifies the electric current that flows through the output inductor L1. It should be noted that a rectifier diode may be employed instead of the synchronous rectification transistor M2.

The switching transistor M1 and the synchronous rectification transistor M2 are turned on and turned off complementarily to each other, thereby generating a switching voltage Vsw which swings between the input voltage Vin and the ground voltage (0 V). One terminal of the output inductor L1 is connected to the switching terminal 102, and the switching voltage Vsw is applied to this terminal. The other terminal thereof is connected to the output terminal 204. The output capacitor C1 is provided between the output terminal 204 and the ground terminal. The output capacitor C1 is charged by the current IL that flows through the output inductor L1.

It should be noted that the switching regulator 200 is not restricted to a step-down switching regulator as shown in FIG. 1. Also, the switching regulator 200 may be either a step-up switching regulator or a step-down switching regulator. Also, the switching regulator 200 may be an insulated switching power supply. Alternatively, other types of power supply apparatuses may be employed, examples of which include a DC/AC converter (inverter), a capacitor charging circuit, etc. An output circuit 110 having a suitable circuit topology can be employed for such modifications, which can be readily understood by a person skilled in this art.

The control circuit 100 includes the switching terminal 102 and a feedback terminal 104. The feedback terminal 104 receives, as an input signal, the feedback voltage Vfb obtained by dividing the output voltage Vout at the output terminal 204 by a first feedback resistor R10 and a second feedback resistor R11.

The control circuit 100 includes a driver 14, a pulse frequency modulator 16, and a pulse width modulator 18, and is a function IC monolithically integrated on a single semiconductor substrate. It should be noted that the switching transistor M1 and the synchronous rectification transistor M2 may be provided as built-in components included within the control circuit 100. Also, these transistors M1 and M2 may be provided as external components. When the load is heavy, the pulse width modulator 18 becomes active, and when the load is light, the pulse frequency modulator 16 becomes active. The driver 14 drives the switching transistor M1 and the synchronous rectification transistor M2 according to a control signal Spfm generated by the pulse frequency modulator 16 or a control signal Spwm generated by the pulse width modulator 18. It should be noted that judgment of whether the load state is a heavy-load state or a light-load state can be made using various known techniques. Accordingly, description thereof will be omitted.

First, description will be made regarding the pulse width modulator 18. The pulse width modulator 18 generates a PWM signal Spwm having a duty ratio adjusted such that the output voltage Vout (feedback voltage Vfb) matches a predetermined reference voltage. The pulse width modulator can be configured using known techniques. Accordingly, description thereof will be omitted.

Next, description will be made regarding the configuration of the pulse frequency modulator 16. The pulse frequency modulator 16 includes a first comparator 10, a second comparator 12, and a logic unit 20.

The first comparator 10 compares the feedback voltage Vfb, which corresponds to the output voltage Vout of the switching regulator 200, with a predetermined lower threshold voltage VthL. If the comparison result indicates that the feedback voltage Vfb has dropped to the threshold voltage VthL, the first comparator 10 outputs a voltage comparison signal Vcomp in the asserted state (the high-level state in the present embodiment).

In FIG. 1, the first comparator 10 is configured as a hysteresis comparator which uses, as threshold voltages, the lower threshold voltage VthL and an upper threshold voltage VthH which is higher than the lower threshold voltage VthL. The hysteresis comparator (10) outputs the voltage comparison signal Vcmp which is asserted (in the high-level state in the present embodiment) when the feedback voltage Vfb is smaller than the threshold voltage Vth. Specifically, during a period in which the voltage comparison signal Vcmp is in the asserted state, the threshold voltage Vth is set to the upper threshold voltage VthH which is a higher threshold voltage, and during a period in which the voltage comparison signal Vcmp is in the negated state (the low-level state in the present embodiment), the threshold voltage Vth is set to the lower level VthL. The first comparator 10 may be a hysteresis comparator. Also, the comparator 10 may have a configuration obtained by combining two comparators which respectively compare the feedback voltage Vfb with the upper threshold voltage VthH and the lower threshold voltage VthL and a logic circuit.

With such an arrangement employing such a hysteresis comparator, the feedback voltage Vfb can be switched between the lower threshold voltage VthL and the upper threshold voltage VthH.

It should be noted that the first comparator 10 may have no hysteresis function. The first comparator 10 may be a simple comparator which compares the feedback voltage Vfb with the lower threshold voltage VthL. Even in such a case, the minimum voltage of the feedback voltage Vfb can be set by the lower threshold voltage VthL.

The second comparator 12 compares a detection current Is that flows through the switching transistor M1 with a predetermined reference current Ic. When the detection current Is reaches the reference current Ic, the second comparator 12 asserts a current comparison signal Icmp (the high-level state in the present specification).

In FIG. 1, the second comparator 12 compares the detection voltage Vs, which corresponds to the detection current Is, with a reference voltage Vth3 that corresponds to the reference current Ic. In order to generate the reference voltage Vth3, a resistor R1 and a current source 13 are provided. The input voltage Vin is applied to one terminal of the resistor R1. The current source 13 is connected to the resistor R1 in series, and generates the predetermined reference current Ic. The reference voltage Vth3 is represented by the following Expression: Vth3=Vin×R1×Ic.

With the ON resistance of the switching transistor M1 as Ron1, and with the current that flows through the switching transistor M1 as IL, the detection voltage Vs is represented by the following Expression: Vs=Vin−Ron1×IL.

In this case, comparison between the detection voltage Vs and the reference voltage Vth3 is equivalent to comparison between the voltage drop (Ron1×IL) across the switching transistor M1 and the voltage drop (R1×Ic) across the resistor R1. In other words, such comparison is equivalent to comparison between the current IL and the reference voltage Ic. It should be noted that the current comparison method is not restricted to such a method described above.

The logic unit 20 receives the voltage comparison signal Vcmp and the current comparison signal Icmp, and generates the control signal Spfm. The control signal Spfm is at a first level (low level) during a period in which the switching transistor M1 is to be turned on, and the control signal Spfm is at a second level (high level) during a period in which the switching transistor M1 is to be turned off.

The driver 14 drives the switching transistor M1 and the synchronous rectification transistor M2 according to the control signal Spfm. Specifically, the driver 14 generates the driving signals SDH and SDL, the logic levels of which are set according to the control signal Spfm, and supplies the driving signals SDH and SDL thus generated to the gates of the switching transistor M1 and the synchronous rectification transistor M2, respectively.

During a period in which the voltage comparison signal Vcmp is in the asserted state, the logic unit 20 repeatedly performs an operation in which, when the current comparison signal Icmp is asserted, the control signal Spfm is set to the second level (high level), following which, after the passage of a predetermined OFF time Toff, the control signal Spfm is set to the first level (low level).

In order to provide such a function, the configuration shown in FIG. 1 can be configured as follows. The logic unit 20 includes an AND gate 22, a first one-shot circuit 24, a flip-flop 26, a second one-shot circuit 28, and an inverter 30.

The logic unit 20 receives a pulse signal (in this case, the driving signal SDH) having a logic level that corresponds to the control signal Spfm. When the pulse signal SDH transits to the first level (low level), the gate signal generating unit 27 generates a gate signal S4 which is asserted (switched to the high-level state) after the passage of the OFF time Toff. For example, the gate signal generating unit 27 includes the second one-shot circuit 28 and the inverter 30. The second one-shot circuit 28 generates a one-shot pulse S3 which is set to the high-level state during a predetermined period (OFF time Toff) after the pulse signal SDH transits to the high-level state. The inverter 30 inverts the one-shot pulse S3, thereby generating the gate signal S4.

The AND gate 22 generates the AND of the gate signal S4 and the voltage comparison signal Vcmp. When the output signal (ON signal) S1 of the AND gate 22 is asserted (set to the high-level state), the first one-shot circuit 24 generates a one-shot pulse S2 having a predetermined pulse width.

The flip-flop 26 generates the control signal Spfm. When the ON signal S1 (i.e., S2) output from the AND gate 22 is asserted, the control signal Spfm is set to the first-level state (high-level state), and when the current comparison signal Icmp is asserted, the control signal Spfm is set to the second level (low-level state).

More specifically, the flip-flop 26 is a D flip-flop. The high-level (first level) signal is input to the input terminal D of the D flip-flop, and a one-shot pulse signal output from the first one-shot circuit 24 is input to the clock terminal thereof. Furthermore, the current comparison signal Icmp is input to the reset terminal of the flip-flop 26. The control signal Spfm is output from the inverting output terminal of the D flip-flop.

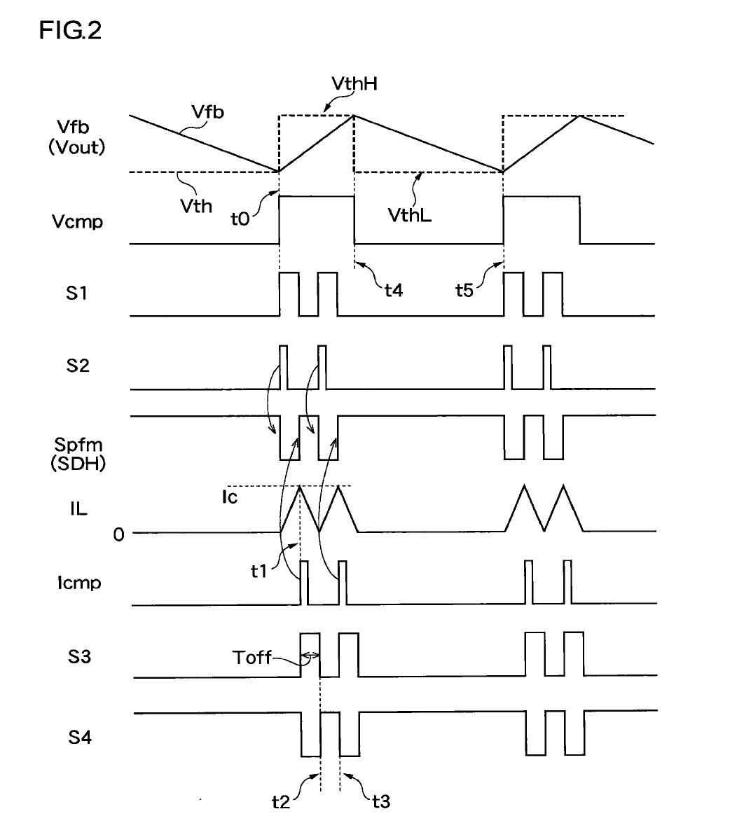

The above is the configuration of the control circuit 100. Next, description will be made regarding the operation thereof. FIG. 2 is a time chart which shows the operation of the control circuit 100 shown in FIG. 1 when the load is light.

When the load is light, the pulse frequency modulator 16 becomes active. In the PFM mode, the synchronous rectification transistor M2 is fixedly turned off. Before the point in time t0, the driving signals SDH and SDL are in the low-level state. Accordingly, the switching transistor M1 and the synchronous rectification transistor M2 are each turned off. In this stage, the charge stored in the output capacitor C1 is supplied to an unshown load, which reduces the feedback voltage Vfb over time. At the point in time t0, the voltage comparison signal Vcmp is in the low-level (negated) state. Accordingly, the threshold voltage of the first comparator 10 is set to the lower level VthL. During this period, the relation Vfb>Vth is satisfied. Furthermore, the driving signal SDH is in the high-level state. Accordingly, the gate signal S4 is maintained at the high level.

When the feedback voltage Vfb drops to the lower threshold VthL at the point in time t0, the voltage comparison signal Vcmp is set to the high-level state (asserted). When this signal is received, the output signal (ON signal) S1 of the AND gate 22 and the output signal (one-shot pulse) S2 of the first one-shot circuit 24 are asserted, and a positive edge is thus input to the clock terminal of the flip-flop 26, thereby switching the inverted output signal (control signal Spfm) to the low-level state. Furthermore, after the point in time t0, the threshold voltage Vth for the first comparator 10 is switched to the higher level VthH.

When the control signal Spfm is switched to the low-level state, the switching transistor M1 is turned on, and the synchronous rectification transistor M2 is turned off. Accordingly, the input voltage Vin is applied to one terminal (switching terminal 102) of the output inductor L1, and the coil current IL thereby starts to increase.

When the current IL that flows through the switching transistor M1 reaches the reference current Ic at the point in time t1, the current comparison signal Icmp is asserted. When the current comparison signal Icmp is asserted, the flip-flop 26 is reset, and the inverted output thereof (control signal Spfm) and the driving signal SDH are switched to the high-level state, thereby turning off the switching transistor M1. After the switching transistor M1 is turned off, the coil current IL starts to drop.

When the driving signal SDH is switched to the high-level state at the point in time t1, the second one-shot circuit 28 generates a one-shot pulse S3 which is maintained at the high level during a predetermined OFF time. The inverted one-shot pulse S3 inverted by the inverter 30, i.e., a gate signal S4, is switched to the high-level state at the point in time t2 after the passage of the OFF time Toff from the point in time t1.

When the gate signal S4 is switched to the high-level state at the point in time t2, the ON signal S1 is switched to the high-level state, thereby turning on the switching transistor M1 again. Subsequently, a similar process is performed so as to turn off the switching transistor M1 at the point in time t3.

After the point in time t0, the switching transistor M1 is intermittently turned on. Thus, the positive coil current IL flows through, and accordingly, the output capacitor C1 is charged, thereby increasing the output voltage Vout (feedback voltage Vfb).

When the feedback voltage Vfb exceeds the threshold voltage Vth (=VthH) at the point in time t4, the voltage comparison signal Vcmp is negated. During a period in which the voltage comparison signal Vcmp is negated, the switching transistor M1 and the synchronous rectification transistor M2 are completely stopped.

When the feedback voltage Vfb drops to the lower threshold voltage VthL at the point in time t5, the voltage comparison signal Vcmp is asserted again. In the light-load state, the control circuit 100 repeatedly performs the series of operations from the points in time t0 to t5.

The above is the operation of the control circuit 100. The control circuit 100 does not require an oscillator to perform an operation for the light-load state, thereby providing a reduced circuit area. Furthermore, such an arrangement that does not require such an oscillator reduces power consumption as compared with conventional techniques.

The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention.

The settings of the logical values of the signals, such as the high-level state and the low-level state of the signals, have been described in the present embodiment for exemplary purposes only. The settings can be freely modified by inverting the signals using inverters or the like.

While the preferred embodiments of the present invention have been described using specific terms, such description is for illustrative purposes only, and it is to be understood that changes and variations may be made without departing from the spirit or scope of the appended claims.

What is claimed is:

1. A control circuit for a switching regulator having a switching transistor, comprising:
a first comparator configured to compare a feedback voltage that corresponds to the output voltage of the switching regulator with a predetermined lower threshold voltage, and to output a voltage comparison signal which is asserted when the feedback voltage drops to the lower threshold voltage;
a second comparator configured to compare an electric current that flows through the switching transistor with a predetermined reference current, and to generate a current comparison signal which is asserted when the current reaches the reference current;
a logic unit configured to receive the voltage comparison signal and the current comparison signal, and to generate a control signal which is set to a first-level state during a period in which the switching transistor is to be turned on, and which is set to a second-level state during a period in which the switching transistor is to be turned off; and
a driver configured to drive the switching transistor according to the control signal,
wherein, during a period in which the voltage comparison signal is asserted, the logic unit repeatedly performs an operation in which, when the current comparison signal is asserted, the control signal is set to the second level, following which, after the passage of a predetermined period of OFF time, the control signal is set to the first level.

2. A control circuit according to claim 1, wherein the first comparator is a hysteresis comparator configured to use, as threshold voltages thereof, the lower threshold voltage and an upper threshold voltage which is higher than the lower threshold voltage,
and wherein, when the feedback voltage is smaller than the threshold voltage, the first comparator asserts the voltage comparison signal.

3. A control circuit according to claim 1, wherein the logic unit comprises:
a gate signal generating unit configured to receive a pulse signal having a logic level that corresponds to the control signal, and to generate a gate signal which is asserted after the passage of the OFF time when the pulse signal is switched to the first level;
an AND gate configured to generate a logical sum of the gate signal and the voltage comparison signal; and
a flip-flop configured to generate the control signal which is set to the first level when the output signal of the AND gate is asserted, and which is set to the second level when the current comparison signal is asserted.

4. A control circuit according to claim 2, wherein the logic unit comprises:
a gate signal generating unit configured to receive a pulse signal having a logic level that corresponds to the control signal, and to generate a gate signal which is asserted after the passage of the OFF time when the pulse signal is switched to the first level;
an AND gate configured to generate a logical sum of the gate signal and the voltage comparison signal; and
a flip-flop configured to generate the control signal which is set to the first level when the output signal of the AND gate is asserted, and which is set to the second level when the current comparison signal is asserted.

5. A control circuit according to claim 3, wherein the logic unit further comprises a first one-shot circuit configured to receive the output signal of the AND gate, and to generate a one-shot pulse having a predetermined pulse width when the output signal is asserted,
and wherein, upon reception of an edge of the one-shot pulse, the flip-flop sets the control signal to the first level.

6. A control circuit according to claim 4, wherein the logic unit further comprises a first one-shot circuit configured to receive the output signal of the AND gate, and to generate a one-shot pulse having a predetermined pulse width when the output signal is asserted,
and wherein, upon reception of an edge of the one-shot pulse, the flip-flop sets the control signal to the first level.

7. A control circuit according to claim 3, wherein the gate signal generating unit comprises:
a second one-shot circuit configured to generate a one-shot pulse which is set to a high-level state during a predetermined OFF time after the pulse signal is switched to a first level; and
an inverter configured to invert the one-shot pulse output from the second one-shot circuit, thereby generating the gate signal.

8. A control circuit according to claim 4, wherein the gate signal generating unit comprises:
a second one-shot circuit configured to generate a one-shot pulse which is set to a high-level state during a predetermined OFF time after the pulse signal is switched to a first level; and
an inverter configured to invert the one-shot pulse output from the second one-shot circuit, thereby generating the gate signal.

9. A switching regulator comprising:
a switching transistor;
an inductor arranged such that a switching voltage generated by turning on and off the switching transistor is applied to the inductor;
a rectifier element configured to rectify a current that flows through the inductor;
an output capacitor charged by the current that flows through the inductor; and
a control circuit according to claim 1, configured to control the ON/OFF operation of the switching transistor.

10. A switching regulator comprising:
a switching transistor;
an inductor arranged such that a switching voltage generated by turning on and off the switching transistor is applied to the inductor;
a rectifier element configured to rectify a current that flows through the inductor;
an output capacitor charged by the current that flows through the inductor; and
a control circuit according to claim 2, configured to control the ON/OFF operation of the switching transistor.

11. A switching regulator comprising:
a switching transistor;
an inductor arranged such that a switching voltage generated by turning on and off the switching transistor is applied to the inductor;
a rectifier element configured to rectify a current that flows through the inductor;
an output capacitor charged by the current that flows through the inductor; and
a control circuit according to claim 3, configured to control the ON/OFF operation of the switching transistor.

12. A switching regulator comprising:
a switching transistor;
an inductor arranged such that a switching voltage generated by turning on and off the switching transistor is applied to the inductor;
a rectifier element configured to rectify a current that flows through the inductor;
an output capacitor charged by the current that flows through the inductor; and
a control circuit according to claim 5, configured to control the ON/OFF operation of the switching transistor.

13. A switching regulator comprising:
a switching transistor;
an inductor arranged such that a switching voltage generated by turning on and off the switching transistor is applied to the inductor;
a rectifier element configured to rectify a current that flows through the inductor;
an output capacitor charged by the current that flows through the inductor; and
a control circuit according to claim 7, configured to control the ON/OFF operation of the switching transistor.

14. A method for controlling the ON/OFF state of a switching transistor included in a switching regulator, comprising:
comparing a feedback voltage that corresponds to the output voltage of the switching regulator with a predetermined lower threshold voltage, and generating a voltage comparison signal which is asserted when the feedback voltage drops to the lower threshold voltage;
comparing an electric current that flows through the switching transistor with a predetermined reference current, and generating a current comparison signal which is asserted when the current reaches the reference current; and
generating, based upon the voltage comparison signal and the current comparison signal, a control signal which is set to a first-level state during a period in which the switching transistor is to be turned on, and which is set to a second-level state during a period in which the switching transistor is to be turned off,
wherein, in the processing for generating the control signal, during a period in which the voltage comparison signal is asserted, an operation is repeatedly performed in which, when the current comparison signal is asserted, the control signal is set to the second level at which the switching transistor is turned off, following which, after the passage of a predetermined OFF time, the control signal is set to the first level at which the switching transistor is turned on.

15. A method according to claim 14, wherein the comparison between the feedback voltage and the lower threshold voltage is made by a hysteresis comparator which uses, as threshold voltages, the lower threshold voltage and an upper threshold voltage which is higher than the lower threshold voltage.
